(19) United States
(12) Patent Application Publication
(10) Pub. No.: US 2026/0290965 A1
(43) Pub. Date: Sep. 24, 2026

(54) BATTERY MODULE AND ENERGY STORAGE RACK

(71) Applicant: RAUL-IOAN RISCO, Pitesti (RO)

(72) Inventor: RAUL-IOAN RISCO, Pitesti (RO)

(21) Appl. No.: 19/477,796

(22) PCT Filed: May 8, 2023
(86) PCT No.: PCT/RO2023/050005

§ 371 Date: Oct. 23, 2025

(30) Foreign Application Priority Data
Apr. 27, 2023 (RO) A202300209

(51) Int. Cl. H01M 50/209; H01M 10/613; H01M 10/647; H01M 10/6563; H01M 10/6566; H01M 50/242; H01M 50/383

(52) U.S. Cl. CPC H01M 50/209; H01M 10/613; H01M 10/647; H01M 10/6563; H01M 10/6566; H01M 50/242; H01M 50/383

(57) ABSTRACT

The invention refers to a module/rack, for storing electrical energy, which is a device consisting of two or more cells/modules, put together by means of composite material plates, rods and connecting elements, resulting in a rigid assembly, having a cooling and/or forced heating system, at the battery cell level. Cooling and/or heating is done by convection and conduction, convection being ensured by a turbine fan and side radiators through which cooling liquid circulates, and conduction, at the cell level, by a heat exchanger made of copper wool or other thermally conductive materials, in direct contact with the surfaces of the battery cells, with controlled humidity.

The module has an anti-fire system, consisting of a flammable gas exhaust system and the injection or spraying of inert gas and/or anti-fire liquid and from ampoules with anti-fire liquid.

FIG. 9 is applied to the abstract.

The present invention is applied in the energy industry, especially in the storage of electricity in stationary batteries Battery Energy Storage System (BESS) and/or in the field of transport, wherein electric vehicles use battery modules, as well as in electric vehicles charging systems, wherein the power grid does not support fast charging and the battery modules of the present invention accumulate energy constantly from the power and capacity of the grid or primary source, and discharge quickly modularly when charging electric vehicles, through energy accumulators, originally from the grid and finally to electric and transport vehicles, where the grid needs storage or buffer for fast or ultra-fast charging.

The present invention has application in energy storage from renewable sources, in electricity rebalancing, as well as energy storage at balancing level between grids or between different stages of power grids, or between consumers and grids and/or between consumers and electricity producers, the most common of which being the production of renewable energy. The present invention, with at least one of the systems to be presented, is applicable where electricity production cannot be synchronized with consumption, where capacity and/or power cannot be synchronized or rebalanced between production and/or distribution, with consumption, and at least one technical solution of the present invention intervenes in the accumulation and supply between primary production and/or distribution, with the consumer. Likewise, it is also used for the purpose of accumulation at low prices and discharge at high prices for compensation between over-production vs consumption and over-demand vs insufficient production.

The present invention is a continuation of the invention and patent application no.: A/00352/2022 of 20 Jun. 2022 titled “Battery cell with electrode, electrically and thermally conductive collector, with internal and external heat exchanger”.

Currently, electrical energy storage systems in batteries, especially lithium-based ones, have the reputation of being dangerous because they have a high risk of fire, uncontrollable rapid heating, chain reactions up to combustion and explosion. In case of fire and/or explosion, the protection and intervention systems are at the level of containerization and of the assembly of modules that act on the whole and not directly at the level of the battery cell, which does not prevent the process of extinguishing the fire at the source and does not stop its propagation.

In current situations, battery modules composed of two or more lithium battery cells are provided with cooling and forced ventilation systems, but with major problems, because they do not have heat transfer onto the radiant and overheated parts or surfaces, without thermal transfer and in particular, which transfers heat from one cell to another, being heated from one another, without discharging the heat with its variations from one surface to another, from one cell to another or from one module to another. Current cooling systems do not cool evenly and homogeneously and do not remove heat from the battery enclosure individually.

Further, the electric energy storage systems in batteries, in particular lithium ones, generate heat that cannot be controlled, the cooling systems do not provide constant cooling and directly to the source, and the heating sources which are actually the individual battery cells in general, where problems arise from a single overheated or overcharged or disbalanced cell, as compared to other battery cells in a module it is part of, because direct cooling is not ensured for each battery cell.

Battery cell life is expressed in charging/discharging cycles. If during operation there are temperature variations, the electrodes and separators and/or the electrolyte in the batteries lose their properties, leading to a significant decrease in charging/discharging cycles and implicitly to a reduction of the service life and/or their degradation becoming dangerous up to combustion. Maintaining a constant operating temperature of the batteries, in particular uniform and without variations between battery cells, regardless of their position in the battery mode, or of the battery modules in the racks or of the racks in the containerization, represent innovative systems and solutions that are an integral part of this invention.

Currently, the assembly of battery cells in modules does not provide high energy density by fixing cells that do not have their own clamping system, battery cells that are multiplied into modules, where the systems prior to the present invention do not have combined assembly with a system of the present invention for homogeneous cooling on each surface and through a heat exchanger attached to the battery cell surfaces, in addition with a housing system that envelops the upper and lower part of the battery cells, especially in the corners for fixing, where the mechanical strength of the battery cells is the highest and ideal for lithium battery cells, to which a fire system is applied directly in the module and directly to each battery cell, representing solutions that are an integral part of the present invention that solve the mentioned problems.

The technical solutions up to the present moment regarding the assembly of modules in racks is a multiplication of battery modules with opening, non-insulated and open, where they are not provided with thermal, electrical and individually compartmentalized insulation, and for any problem, the propagation of combustion or fire, general contamination with combustible and/or explosive gas and their propagation from one module to another or from one rack to another is inevitable and cannot be contained or stopped, although a problem arises only from one battery cell, from one battery cell module in a rack, and the fire and exhaust and/or suction systems act at containerization level, after the propagation and the chain reaction that affected the entire system, where these problems are solved through the systems, processes and solutions applied in the present invention.

Likewise, the module has the role of keeping the defective battery cells in place, knowing that in a defective cell, the cell walls expand, thus affecting the cells around it. By keeping them in place, the cells around the defective one will be less affected and will continue to operate, and the spaces between the battery cells with heat exchangers that can be made of copper wool or other heat conductive material, will allow the volume of the defective battery cell to expand.

Lithium cells, especially the prismatic ones, are not provided with a fixing structure to assemble them into modules of two or more cells. They only have an aluminium box for encapsulating anode-cathode rolls. Consequently, they do not have a mechanical structure and are fragile during assembly, transport and physical (mechanical) stress and/or vibrations, bearing in mind that they also have a weight of 2000 Kg/m3 where handling, vibrations and inertia have a negative impact on the electrodes they are part of and which are run at micron level. In the event of deformation or cracking, there is a risk of fire and explosion. In the present invention, the assembly module of two or more cells is provided with a composite structure that can consist of one or more upper and lower plates, wherein the battery cells are embedded, with vertical rods between the plates, to create a structure of strength and protection to lithium cells from one end to the other, and from one surface to another, mechanical strength on 3 axes and oblique, along the length/width/height/diagonal.

The module system of the present invention is provided with forced cold air-cooling with controlled temperature at the level of each cell independently and/or at the level of each of the 6 surfaces, where the heating of one cell from another cell is excluded. Each cell is cooled homogeneously and independently and the forced air exit between the cells is in a closed circuit and cooled immediately, from the forced air exit between the cells it is directed and in closed circuit to the heat exchangers, radiators that can be liquid radiators located in the vicinity and/or near the heat source. Heat exchangers are applied and/or attached to the battery cells' surfaces, according to the invention and to patent application No.: A/00352/2022 of 20 Jun. 2022, in particular, according to claims 7, 8, 9, 10.

Battery modules consisting of two or more battery cells are cooled on their surface or surfaces with forced air, relying not only on the thermal conductivity of the air but also through heat exchanger or exchangers and in an air-liquid hybrid manner, such systems and processes being part of the present invention.

The module system of the present invention is provided with a heat exchanger attached to the surfaces of the cells made of thermally conductive material which can be from heat exchangers on the surfaces of the battery cells, which transfers heat from the cell surfaces and through the material, not only through air forced through convection but also comprising through material conductivity.

The battery modules, consisting of two or more battery cells, are ventilated with forced air, with air circulation fan, with distributor and air flow control, between the cells on all surfaces, without exception.

The cooling system of the module, of the present invention, is provided with a turbine fan that directs and distributes the air current through two slits resulting from the module construction, one at the upper level and the other at the lower level, it creates at least one pressurized chamber, but ideally and representing an integral part of the present invention, it creates two mirrored and opposite pressurized chambers, and it distributes the entire air flow uniformly and controlled, to each surface of the cells that make up a battery module. The pressure chamber or chambers distribute(s) the forced air evenly or uniformly upward towards the side further away from the source, for a constant and homogeneous cooling at the module level.

The system of the present invention is also a closed circuit where we have pressure, exhaust, distribution, absorption and suction, where their combination increases and amplifies the speed of the air forced and distributed uniformly and controlled through all the villosities of the battery module or the faces of all the cells. In order to reach and cool efficiently at the opposite end, the system is provided with an increasing number of additional holes for proportional cooling ΔT vs. flow, and where the temperature difference ΔT is higher, the forced air flow rate is lower, and where the temperature difference ΔT is lower, the forced air flow rate is higher for compensation, and the result is the obtainment of a homogeneous cooling system.

The battery modules composed of two or more battery cells are provided with a fire protection system and/or flammable and combustible gas exhaust system, in the event of problems and/or electrochemical reaction of the defective cells.

The system of battery modules herein is provided with a flammable and combustible gas suction system in the event of problems and/or electrochemical reaction of defective cells, which switches from a closed-circuit system to an open system with suction and exhaust circuit.

Prior to the present invention, battery modules consisting of two or more battery cells had fire-protection and/or anti-fire systems at the level of groups of modules or at the level of containerization, acting upon the assembly but also with effect when the fire is triggered and propagated to the assembly, when it is very late and dangerous, taking into account that the triggering is done only from one and first defective cell, which stands at the origin of the problem.

The system of the present invention is intended to act directly and promptly on any battery cell with problems, from the first signs of failure or danger, directly to the battery cell, inside any module of which the defective battery cell is a part, both by cooling, extinguishing and exhaust, and the compartmentalization of the isolated modules do not allow the propagation between modules or the expansion to the rack or racks, the system of assemblies, sub-assemblies and processes that form an integral part of the present invention.

The system of the present invention can also be provided with anti-fire liquid ampoules, inside the battery modules, which are in the immediate vicinity of each battery cell, where each of the battery cells is provided with a fire extinguisher which acts directly at the source and/or directly on the flame or on the reaction caused by the failure of the battery cell or cells, without allowing the fire propagation or expansion, thus keeping the problem closed and isolated at the level of that particular module, without contaminating/affecting the other healthy battery modules.

The anti-fire system of the present invention acts directly on the battery module of the present invention and inside the battery module comprising fire-protection systems, and/or thermal barrier and/or fire propagation barriers to other modules in the battery module group of the present invention.

The system of the present invention is also provided with a controlled triggering system of anti-fire or fire-protection ampoules, when fire and/or open flame and/or combustible and/or flammable gas is detected, so that it acts directly on the fire or open flame by flammable electrochemical reaction.

The system of the present invention can also be provided with a grid, distribution and inert gas injection device that can be mixed with a flame extinguishing agent directly at each battery module, inside it, that can be triggered independently by an actuator that triggers the admission and injection of the fire-protection agent and/or of the mixture of inert gas with fire-protection agent, but it also opens the hatches and enclosures from the closed, compartmentalized and isolated module, towards the exhaust and/or exhaust with the suction of combustible gases and/or of the smoke produced by the defective cell or cells. The intervention injection in the anti-fire process also brings a supply of anti-flammable material, for the cooling and diluting of the combustible material, directly inside the battery module and exactly above the battery cells, so exactly at the source, for the extinguishing intervention, exhaust and stop of propagation.

The technical problem solved by the invention consists in the composite structure for cells and battery modules, of uniform and/or homogeneous cooling and fire-protection and/or anti-fire with extinguishing solution, propagation and/or exhaust and/or suction.

The solution to the technical problems is presented in independent claims 1, 2 and 3, creating preferences of the solution invention and of execution in the dependent claims 4, 5, 6, 7, 8, 9, 10, 11, 12, 13, 14, 15 and 16, and make the object on which they depend.

It will be appreciated that one or more of the elements depicted in the drawings/figures may also be implemented in a more separate or integrated manner, or even eliminated in certain cases, as useful in accordance with a particular application.

Also, the rates, dimensions, distances, scale, sizes and proportions in the figures, but not limited thereto, are only for the understanding and explanation of the present invention, for presenting the solutions to the problems.

The terms used singularly can be applied in plural and vice versa, to objects, assemblies, sub-assemblies, processes, substances, in any description, figures and claims of the present invention.

### Legend (Terms, Explanations and Changes)

L1. Battery module—assembly consisting of two or more batteries, assembled by means of composite material plates, with specially designed housings and rods, resulting in a rigid assembly, which resists to mechanical deformation, connected to one other from an electrical point of view and which is used to store/supply electricity.

L2. Battery cells can be prismatic, pouch or cylindrical—and represent the form in which battery cells can be produced.

L3. Cooling system—assembly consisting of one or more elements whose purpose is to cool the cells inside the module, consisting of a turbine fan, metal elements and radiators, the cooling being achieved by conduction and convection.

L4. Air/water hybrid system—refers to the combination of two cooling systems consisting of an air circuit, complementary to a water circuit.

L5. Copper wool or other material with thermally conductive qualities—copper wires/other material, the arrangement and size of which form a compact body in the form of a compact layer, soft and with thermally conductive properties.

L6. Smoke exhaust system—is an assembly consisting of valve/damper, smoke exhaust pipes, suction motor, smoke sensor (for example hydrogen—H2, but not limited), electric control circuit, pressure-actuated piston with actuator and spray injector function, removable metal hatch, which has the purpose of exhausting the smoke in the event of a cell failure and the emission of smoke by it.

L7. Fire-protection systems—
a. system consisting of ampoules with fire extinguishing liquid, mounted inside the battery module at cell level;
b. inert gas injection and dispersion system, which aims to dilute and maintain the gases/smoke emanating from the defective cell up to the level where it is not flammable and the possibility of liquid/vapour fire extinguishing injection through the same system.

L8. Forced ventilation—the action of the fan on the air by creating a current with a higher speed inside the module.

L9. Battery Management System (BMS)—electronic system that ensures uniform charging/discharging of the batteries inside the module and through which data received from the sensors located on the cells, relating to pressure, humidity, temperature and the presence of gas/smoke is monitored/transmitted.

L10. Rack—cabinet, composite metal frame on which several battery modules can be fixed, with the aim of forming a system of greater size and power.

L11. Standby state—intermediate state in which the battery cells are neither being charged nor discharged.

L12. Data communication—analogue/digital system transmission of data provided by BMS sensors or other component elements of the battery module/rack.

L13. Monitoring—monitoring through a data transmission network/Internet, of the information transmitted by different sensors.

L14. Dispatch—the action of remote operative and permanent control and regulation of a module, rack/cabinet or container.

L15. Energy storage—the action of charging a battery/module/rack/cabinet with electrical energy for later use.

L16. Anti-fire ampoules—ampoules made of glass or similar composite material, which break at high temperature due to the action of an external factor.

L17. Walls made of fibre cement or other materials (e.g., silicate)—fibre-reinforced boards from different materials whose purpose is fireproofing and thermal insulation between modules and ensuring the tightness of a module.

L18. Pressure, temperature, humidity, gas/smoke detection sensors—sensors connected to the BMS that aim at monitoring the correct operation of the cells and at warning in case of failure.

L19. Electrical connections—all the cables that ensure the connections between the current source/sources, consumers and racks/modules.

L20. Joining elements—all the elements that ensure the joining and maintaining into position of the metallic/non-metallic elements in the module/rack/container.

L21. Humidifier: water spray device that aims at maintaining a certain humidity percentage in the module/rack/container, for the proper functioning of the cells.

L22. Worm for directing the forced air current from the turbine fan, by dividing into opposite directions of and/or towards the compression areas.

The battery module of the present invention can use prismatic, pouch or cylindrical lithium battery cells, the battery module of the present invention having:
structure and/or/with assembly system of battery cells;
resistance structure with at least one of the composite material devices of the present invention for mechanical protection, impact, vibration, resistance to deformation, pressure, torsion, impact and vibration;
cooling system and/or with multi-directional forced ventilation system in closed circuit and in conversion (hybrid) with adjacent liquid cooling system;
system of heat exchangers on the surfaces of all battery cells with a system of inlets and outlets of the air flow, directed and regulated to each cooling surface and of each heat exchanger, with fresh ventilation, without heating from one cell to another, and with uniform cooling both in the centre and on the edges, uniform and calibrated;
humidification system to allow cooling through a forced closed air circuit with controlled humidity;
anti-fire system and/or/with a smoke exhaust system, which can also be with a suction system directly at the level of battery cells and/or inside the battery module composed of at least two prismatic, pouch or cylindrical type battery cells, representing the battery module of the present invention;
anti-fire system and/or extinguishing system by supplying the anti-fire product at the level of the battery cell or at the level of the battery module consisting of at least two battery cells, through a system of pre-installed ampoules at and between the battery cells or in the battery modules, and/or by injecting the anti-fire product directly to the battery cell or inside the battery module, through an anti-fire system in the distribution grid of the anti-fire product, with an actuation and injection system inside the battery module of the present invention;
actuation and triggering system of the anti-fire process, through actuators and smoke column and/or exhaust and/or suction opening hatches, which are an integral part of the present invention;
anti-fire product intake and injection system that can be also mixed with an inert gas for the application of the anti-fire process in intervention and/or exhaust steps;
control system and sensors for pressure, temperature, humidity, combustible and/or explosive gas (H2) and/or of other relevant gases/that indicate fire;
system for compartmentalization and electrical and thermal insulation, self-ventilation, fire propagation isolation, tightness and mechanical resistance of the battery modules of the present invention.

The battery module rack of the present invention can be composed of previously presented modules, having:
structure and assembly system with mechanical resistance properties and installation devices for liquid-based cooling network and the distribution and supply network in anti-fire product;
mechanical tightness system, thermal insulation and fire and/or flame propagation insulation;
systems of keys and fasteners between racks or in containerization;
liquid cooling system with heat exchangers and/or radiators for each compartment and/or battery module;
smoke exhaust and/or suction system from each compartment and/or module through the battery module exhaust hatch and the rack exhaust hatch at the battery module compartment level, with at least one actuator and/or actuation or opening valve for the continuity of the smoke column;
smoke exhaust columns that can be with central forced suction or per columns at each rack, and which are an integral part of the present invention.
humidification system of the modules' environment, because the difference in temperature creates condensation, and through condensation the environment dries out, and thermal transfer does occur in a dry environment and maintaining the environment at a constant humidity suitable for the cooling system is essential, and the intake is controlled through humidification directly at the module level, through the humidification network that belongs to the rack, is one of the systems integrated in the battery module rack and is an integral part of the present invention.

### DESCRIPTION OF THE DRAWINGS

FIG. 1—illustrates the battery module comprising one or more battery cells 101, with the discharge surface 167, with the upper and lower perimeter with the corners 121 of the battery cells, with heat exchanger 102 attached to the surfaces of the battery cells, where 102a can represent the side faces, 102b the upper face and 102c the lower face, respectively, with the upper and/or lower fixing plate 103, with rods 104 between the plates, and the area of the compression chamber 111 with the cover 120.

FIG. 2—illustrates the fixing plate with a composite structure system that can be through the battery cells structure and embedding base 105, with the structure and resistance struts 106 and their ends 107, and/or at the ends of the plates and of the battery module and/or with the casing 110 outer to the base, with distribution holes 108 of the forced air between the battery cells, with the embedding and fixing housing 109 of the battery cells, fixed by the resistance parts of the battery cells which are the upper and lower perimeters, and comprising the corners of the battery cells in the lower and/or upper plates 103, and the discharge surface 167 being also represented. Also illustrated are joints and clamping keys 119, between the base and the casing at the level of spars.

FIG. 3—illustrates the upper and/or lower fixing plate with the hermetic zone 111 at, for, on, and/or under the battery cells, pressurizing the cooling air and distributing the flow rate through the holes 108 that direct the cooling air between the battery cells and directly to and forced through the heat exchangers of the battery cells, with structural attachment holes 112 for the rods 104, with the sealing flange 113 to which a ventilation sub-assembly can be attached, and where the compressive strength A, and/or bending strength B, and/or shear strength C, and/or tensile strength D are illustrated. Also represented are the joining area or areas 122 by fixing and tightening with the base plate 103, lower and/or upper, through rods 104, with shoulders 123, between bases 105 and casing 110, representing the structure and fixing keys of the present invention.

FIG. 4—illustrates the front subassembly 117 with the turbine fan 114, which sucks the air from opposite sides outside the battery module, which can be lateral 115, where the turbine fan 114 and through the outer circle of the turbine 129 can pressurize and force it angularly to the intake, through at least one area, but preferably multiple areas 116, which can be opposed, where 116 represents the forced cooling air through the worms 127-128, to and inside the battery module of the present invention. The front sub-assembly 117 can be fixed with the body of the battery module through the holes 118 directly to the struts 106. The worms 127-128 are projected through the TX tangents of one side to the outer circle of the turbine fan.

FIG. 5—illustrates the battery module of the present invention with the front sub-assembly 117 composed of the turbine fan 114, with side inlets 115, with pressure chamber areas 124, and the covers 120 external to the module and the slots and/or hot air directing windows 125. The distribution ports 108 of the cold pressurized air 126 are also represented. 126. In the system of the present invention, a heat exchanger 153 directly to the battery cell electrode bars is also presented.

FIG. 6—illustrates the cooling circuit of the forced, controlled and distributed air composed of the inlet and or inlets 115, separation and pressurization in the areas 116 that can be opposite, compressed in the pressure chambers and/or hermetic pressurization areas 124, preferably up 124a and 124b respectively, formed by the bases of the module of the present invention and the outer covers 120 characterized by the volume 111, from where cold air is injected through the holes 108 directly between the battery cells.

FIG. 7—illustrates the forced cold air circuit, from the intake 115 through the turbine fan 114, directed and forced oppositely through the worms 127-128, through the front subassembly 117, with continuation through pressure chambers and directed to cross the heat exchangers of the battery cells where it is heated, and where it is further redirected through the cover openings through slots and/or windows 125, forced and guided through the liquid cooled radiators 130 where it is cooled, and sucked in through the outside of the radiators 131 which continues to be sucked in through the intake 115, and which forms a closed circuit, a system that is an integral part of the present invention.

FIG. 8—illustrates Battery Management System (BMS) represented in 169 with insulation and compartmentalization by fibre cement wall 133, cooled through holes 132, installed opposite to the turbine fan, but cooled by pressure chambers and areas 124/FIG. 5/FIG. 6, with cold air and circulated through the same closed cooling system of the battery module of the present invention, also comprising hydrogen sensor 163, pressure sensor 164, temperature sensor 165, humidity sensor 166.

FIG. 9—illustrates fire-protection and anti-fire system with actuation and/or activator, injection and smoke hatch at module level, with inert gas and fire-protection mixture distribution and injection network 134, with injector actuator and activation cylinder 135, which, through the rod 136, pushes and opens the smoke exhaust hatch 137, which can also be supported by magnets 152 and which detaches from the module and slides 138 for the opening and continuity of the smoke column and the exhaust of smoke especially from the battery cells that have discharge valves 139 in their upper part. Heat exchangers 162 are also shown, directly at the electrode terminals and or electrode bars 161 of the battery cells. The discharge valve surface 139 on the discharge surface 167 of the battery cells is also represented.

FIG. 10—illustrates a triggering system at the battery module level, with inert gas and/or fire-protection agent mixture distribution network 141, which may be at rack level, inert gas and fire-protection agent mixture distribution through 134, triggered by the piston 135 which, through the network pressure, moves to the holes 140 which injects the inert gas and, mixed with the fire-protection agent directly at the surface of the room area 124a and simultaneously pushes the rod 136 which moves the hatch 137 which can rotate 138 around the axis 142 and which opens and transforms the area 124a from the pressurized chamber into an open exhaust area for the smoke column that may contain, but separately, also the humidification network 146.

FIG. 11—illustrates a smoke hatch system 143 for opening the smoke column at rack and floor level, supported in the closed position by magnets 145, with the hook 144 for opening and pulling from the closed position through the hatch 137 of the battery module, being also allowed to be supported by the magnets 152/FIG. 10 which, by vertical movement and rotation after being pushed by the rod 136, falls on the hook 144 which in turn pulls and opens the hatch 143, and the smoke column is opened both at the level of the module and at floor and/or rack level and the smoke can escape without obstruction.

FIG. 12—illustrates the module rack of the present invention, which is provided with fiber cement walls 148, metal structure 149, smoke exhaust column 147, liquid cooling network 150, liquid cooling radiators 151 at each module and/or floor and preferably on two lateral sides.

FIG. 13—illustrates the rack of battery modules 155, with metal structure 160 through which the liquid cooling circuit networks 157-158 and the respective inert gas mixed with fire-protection agent networks 141 can be embedded 156 in the structure, and further the rack can be provided with the sub-assembly system 159 of walls made of fibre cement sheets forming a sub-assembly with the cooling radiators on the sides of the modules 159. Also shown are the geometry of the rack frame 160 designed for embedding cooling and inert gas with fire-protection agent mixture networks and with joining keys 168 and fixing between racks and/or racks in containerization Battery Energy Storage System (BESS).

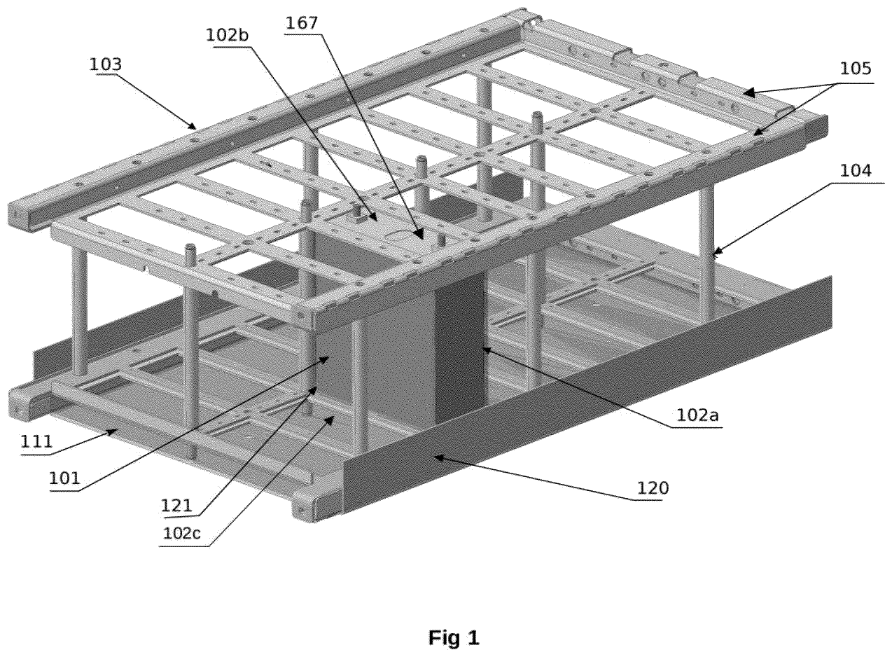

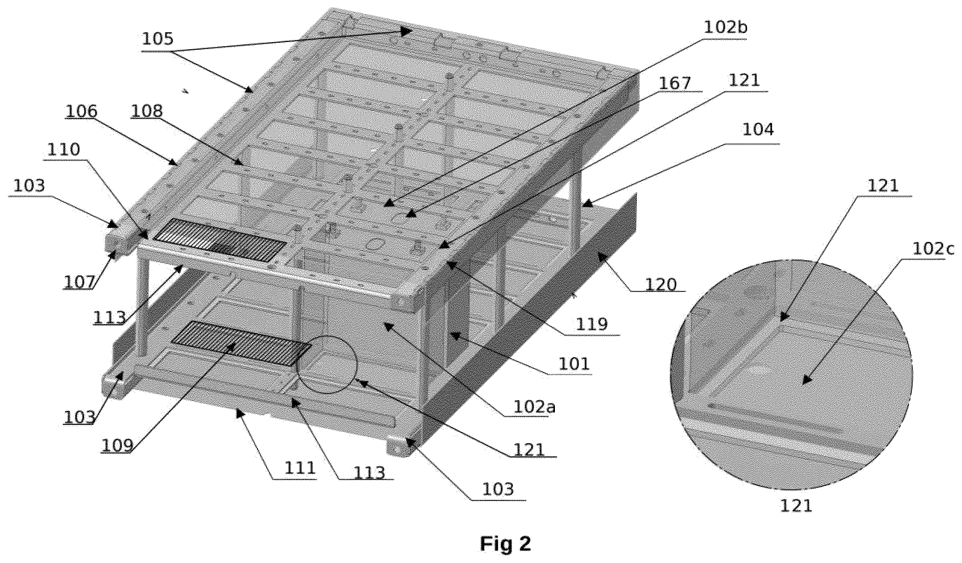

In the present invention, the battery module FIG. 1 consisting of battery cells 101/FIG. 1, are embedded in the lower and upper part as the base 105/FIG. 1 with a depth of 2-40 millimetres in the fixing plate 103/FIG. 1. through the base 105/FIG. 2. where the battery cells have the greatest mechanical resistance, leaving the cooling surface open on the entire perimeter of the cells with their 6 faces and of the heat exchangers 102/FIG. 1.

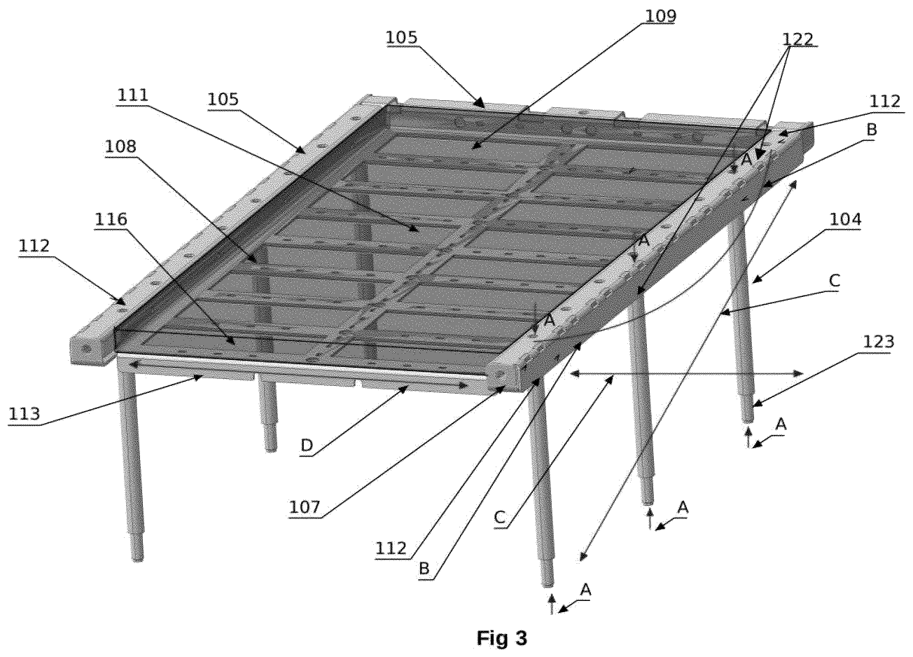

Fixing plate 103/FIG. 1/FIG. 3, can include both the base plate with the casing plate and/or device made of one or more fully machined materials, and/or by molten and/or injected material, such as aluminium, iron, ferrous and/or non-ferrous materials, and/or plastic, fiberglass, resin, polymers, expanded PU, or combination of listed materials, coated and or layered with each other through known industrial operations and processes, which represent integral part of the present invention.

The rods 104/FIG. 1. respectively 104/FIG. 2. cross the system vertically, from one end to the other, all the pressure and mechanical stress being supported by the assembly described and represented in FIG. 1/FIG. 2/FIG. 3 and where in the fixing plates 103/FIG. 2. the base 105/FIG. 2 is embedded into the casing 110/FIG. 2. which forms a composite structure, and which is an integral part of the present invention, protecting against any mechanical stress directly upon the battery cells 101/FIG. 1. The upper and lower plates 103/FIG. 1, in the outer parts of the battery cells, are provided with open areas 108/FIG. 2. which form a chamber used under pressure 111/FIG. 1, respectively 111/Fig., to evenly distribute the cooling air flow above and below the cells. To create the system in a closed circuit, the slots are closed with lower and upper cover 120/FIG. 2, respectively 120/FIG. 3, to ensure positive pressure and uniform flow through the transverse holes of the plates 108/FIG. 2 respectively 108/FIG. 3.

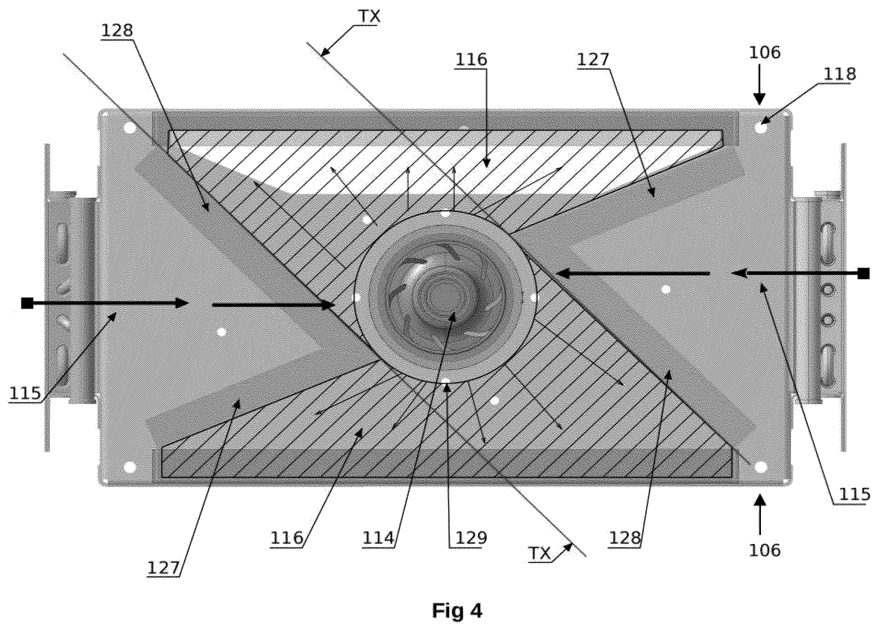

The structure of the battery module of the present invention is composed of the upper and/or lower fixing plate 103/FIG. 1/FIG. 2/FIG. 3, which in turn is made of solid or composite material consisting of two or more plates, such as casing 110/FIG. 2/FIG. 3. with the base 105/FIG. 2./FIG. 3, in which the battery cells are embedded 121/FIG. 1, where the plate or plates, in turn, can also have a bent, layered, cut shape so that they can fit into each other, drilled for the holes 108/FIG. 2/FIG. 3, with base plate or plates 103/FIG. 1/FIG. 2/FIG. 3. to form the struts 106/FIG. 2/FIG. 4. with/through the joining area of the composite structure 122/FIG. 3. through the keys and joints 119/FIG. 3 between the base 105/FIG. 3 with the casing 110/FIG. 2 and the rods 104/FIG. 1, joined and/or closed joints in the axes and/or resistance structure or structures A/B/C/D/represented in FIG. 3. The holes in the spars 112/FIG. 3. can be provided with cylindrical spacers inside the struts, or the holes in the struts 112/FIG. 3. can have different diameters and the rods 104/FIG. 1./FIG. 3. have different cylindrical diameters at the ends 123/FIG. 3, to tighten the fixing plates 103/FIG. 1/FIG. 2/FIG. 3. by means of the struts 122/FIG. 3 with all surfaces, both with the base plate 105/FIG. 2/FIG. 3 and with the casing plate 110/FIG. 2/FIG. 3 for the reinforcement and stiffening of the upper/lower plate or plates in which the battery cells are embedded.

The vertical structure of the battery module of the present invention is composed of rods 104/FIG. 1/FIG. 3. which can be calculated according to the height of the battery cells minus their embedment plus an offset coefficient or tolerance, rods that are embedded in the struts of the upper and lower plates, which in turn are placed and tightened on the shoulders of the rods 123/FIG. 1/FIG. 3, thus ensuring resistance to lateral but also to axial mechanical stress (or compression), and does not leave strain on the battery cells, creating a vertically, horizontally and diagonally protected space. The rods ensure the continuity and strength of the assembly from the outer covers 120/FIG. 1/FIG. 2.

The battery module of the present invention comprising at least one of the composite elements of the structure have the particularities of resistance represented in FIG. 3 with at least one of: compression resistance A/FIG. 3, and/or bending resistance B/FIG. 3, and/or shear strength C/FIG. 3, and/or tensile strength D/FIG. 3.

Lithium cells, through their operation during charging and discharging, including through their internal resistance, generate heat. The system of the present invention, through the described module, allows constant homogeneous cooling at each open cell surface. Previously presented, the cells are embedded in the lower and the upper plate but with the side faces open. The spaces allocated between the cells allow the implementation of a thermally conductive material which in turn absorbs and transfers the heat generated by the cells and transfers it further, depending on the air flow. The battery module of the present invention can be equipped with a turbine fan that ensures the airflow necessary for constant and uniform cooling, in a closed circuit.

In the field of electric energy storage, battery modules are assembled with two or more cells. They release heat that endangers the functionality of the batteries and increases the internal resistance. The module of the present invention is equipped with a hybrid air-liquid cooling system where the air represents a closed circuit and where the heat source and the cooling source are very close, with high thermal transfer through copper wool or other thermally conductive material attached to all battery surfaces and with a liquid circuit that takes over the heat from the air circuit, thus ensuring heat transfer to the outside of the battery modules.

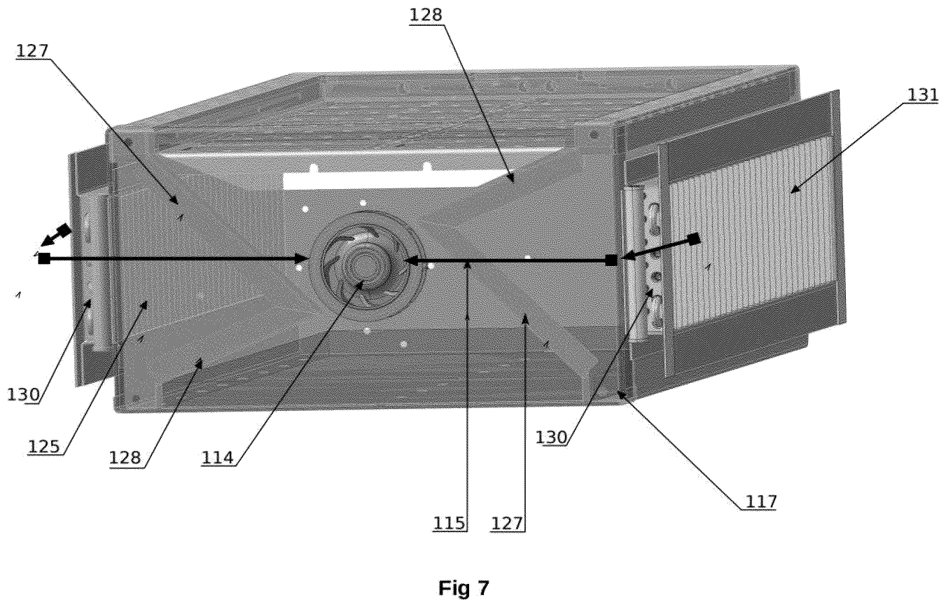

FIG. 7 shows the liquid cooling network, which is composed of lateral radiators at each self-standing module of the cabinet, and the forced air from the turbines of the battery module ensures a constant flow: turbines IN, turbines OUT, top-bottom distribution worm, slot and pressure volume of the top-bottom plates, distribution of cold air through holes between the cells, forced and guided through and crossing heat exchangers on the surfaces of the battery cells, after which it is directed through side radiators, and at the level of the side walls the suction part takes place, after which the IN turbine is reached, being a circular system in a closed circuit.

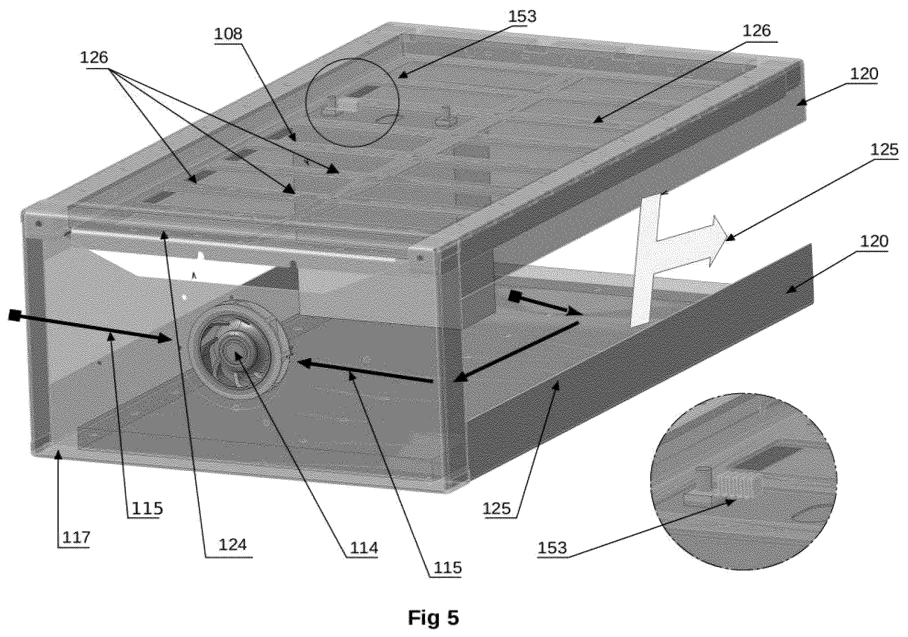

Outer covers 120/FIG. 1/FIG. 2. of the battery module of the present invention, ensure the tightness of the cooling slots 124/FIG. 5. but also, the electrical and mechanical protection of the battery modules of the present invention. The lower and upper covers laterally obstruct the windows and/or the exhaust slots 125/FIG. 5. of hot air and force the air flow to cross the side radiators for cooling the system, guiding and cooling system that is an integral part of the present invention.

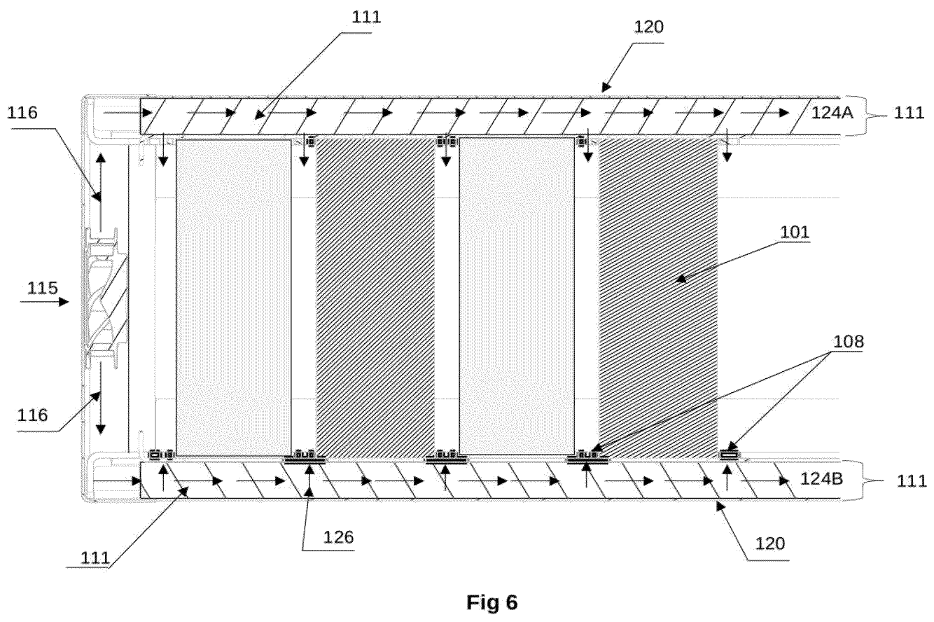

The forced air circuit of the present invention is represented in FIG. 5 and FIG. 6 where the cold air is sucked in and with intake from the sides 115/FIG. 5/FIG. 6. it is pushed and guided in at least one direction but preferably in two opposite directions through slots 124/FIG. 5/FIG. 6. in the hermetic pressurization areas and/or compression chambers 111/FIG. 2/FIG. 2/FIG. 6 and distributed or injected in a controlled manner through the holes 108/FIG. 2/FIG. 3/FIG. 5/FIG. 6 which, in their turn, they are distributed in an increasing manner to ensure an efficient cooling up to the opposite end, wherein the system of the present invention is provided with additional holes in an increasing number for a proportional cooling ΔT vs flow rate, and where the temperature difference ΔT is greater, the flow rate of forced air is lower, and where the temperature difference ΔT is lower, the forced air flow rate is higher for compensation, and the result is the obtainment of a homogeneous cooling system.

The holes are arranged in trapezoidal geometry 126/FIG. 5. to ensure uniform cooling along the entire length of the battery module, by increasing the flow and the increasing distribution of the air flow rate towards the part farthest from the source, respectively from the turbine fan, considering that the air heats up as it crosses the surfaces of the previous cells.

The cold air is forced through the holes 108/FIG. 6. and directed to penetrate the heat exchangers on the surfaces of the battery cells, and by the opposite injection from above and below from areas 124a and 124b/FIG. 6, the system of the present invention cools all the battery cells, directly onto all their surfaces and does not allow any heating from one cell to another, just absolute individual cooling.

In the present invention, a closed-circuit cooling system is presented with a forced air and air/liquid hybrid circulation through at least one heat exchanger, but preferably two heat exchangers, one between the cold air and the surfaces of the battery cells which generate heat, and another, between hot air and liquid cooling radiators to remove heat from the system and/or from the battery modules or module racks, respectively. The forced cold air circuit is sucked in through the intake 115/FIG. 5/FIG. 6, through the turbine fan 114/FIG. 5/FIG. 6, oriented and forced opposite through the worms 127-128/FIG. 4, through the sub-assembly 117/FIG. 5, with continuation through pressure chambers and directed to cross the heat exchangers of the battery cells where it is heated, and where it is further redirected between the openings of the covers respectively of the slots and/or windows 125/FIG. 5/FIG. 7, forced and guided to pass through the liquid cooled radiators 130/FIG. 7. where it is cooled and sucked in through the outside of the radiators 131/FIG. 7. which continues to be sucked in through the intake 115/FIG. 7. and which forms a closed circuit, a system that is an integral part of the present invention and the air is forced and pushed only through the upper slot 124a/FIG. 5/FIG. 6. respectively 124bFIG. 5/FIG. 6. and lower slot of the module, with balanced air flow.

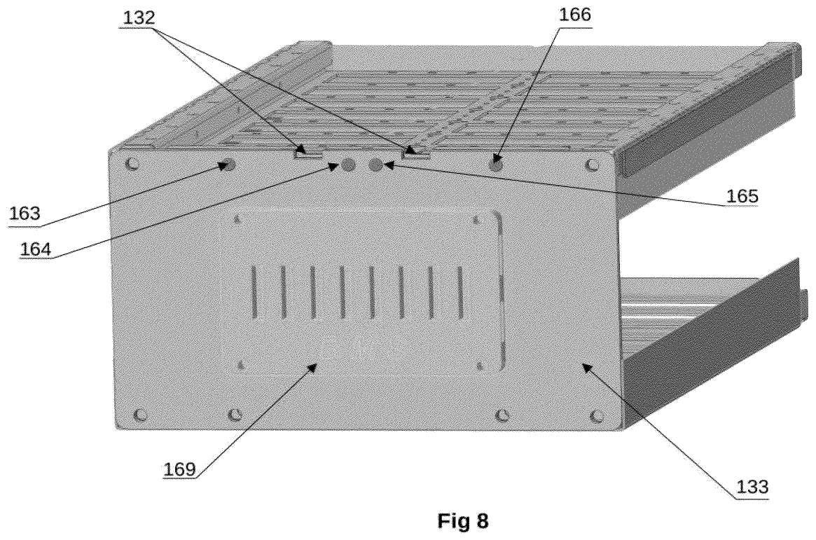

The closed forced cooling circuit of the present invention can be driven by a forced ventilation system, by starting, stopping and through variable and/or adjustable speed of the turbine fan 114/FIG. 5, through a temperature sensor, where the particular turbine fan can be controlled by a Pulsed Wave Modulation (PWM) generator system and/or by the Battery Management System (BMS) 169/FIG. 8.

For bidirectional air flow, which can preferably be upward, downward and opposite, the battery module is equipped with two worms 127-128/FIG. 4. in the front sub-assembly 117/FIG. 4/FIG. 5, designed to force the air equally both upward 124aFIG. 4/FIG. 6 and downward 124bFIG. 4/FIG. 6. from the area or areas 116/FIG. 3/FIG. 4/FIG. 6, opposite according to the drawing in 127/FIG. 4 through which air is forced and pushed only through the upper and lower slot of the module 111/FIG. 6, with balanced air flow rate. The worms 127-128/FIG. 4. of the present invention are designed through the tangent of the point TX/FIG. 4, to the circle of the turbine 129/FIG. 4, and preferably close to the outer circumference of the turbine, because the closer the point TX/FIG. 4.is to the turbine blade, the higher the pressure is and the more forced is the cooling distribution and the efficiency with prompt response in rapid heating cycles of the battery cells.

The module of the present invention, ensures a closed hybrid air flow through the positive pressure of the turbine fan, in the upward and downward capillary direction, comprising worms for directing the forced air current from the turbine fan by dividing in opposite directions of and/or towards the compression areas. through the lower and upper plates but also the negative suction pressure at the turbine intake which increases the speed of the air in the circuit shown in FIG. 7, after which it can be transferred through a separate circuit from the liquid and pumped to the central level of the racks through another network of heat exchangers with the external environment.

The cooling system of the present invention can also have a cooling system directly at the anode-cathode terminals of the battery cells. It is composed of bars and/or radiators 153/FIG. 5. of copper or aluminium that form a series of or connect the battery cells between them, terminals that are located in the cooling chamber under pressure under the cold air flow and flow rate coming from the turbine fan. The bars from 153/FIG. 5. can be electrically insulated with thermally conductive materials such as Boron Nitrate, which becomes a heat exchanger through the bars in 153/FIG. 5. directly to the anode and cathode of the battery cells, where the heat exchange takes place with the internal battery and with the cold air flow from the exhaust of the turbine fan, being the shortest place between the heat source and the cooling source with the highest temperature difference between the cold air from the turbine outlet and the heat generated by the battery cells, and on top of that, with the highest speed of the cold air flow, which is also the freshest.

The hybrid air-liquid cooling system of the present invention includes the liquid-based radiators 130/FIG. 7. which can be an integral part of a liquid cooling system with heat exchangers with the external environment of the battery module of the present invention, driven by the compressor with refrigerants and external radiators in the external environment.

Due to the temperature differences between the cold sources and the hot sources, the environment inside the module becomes dry and reduces the thermal conductivity, which is an essential factor of the closed-circuit forced air-cooling system.

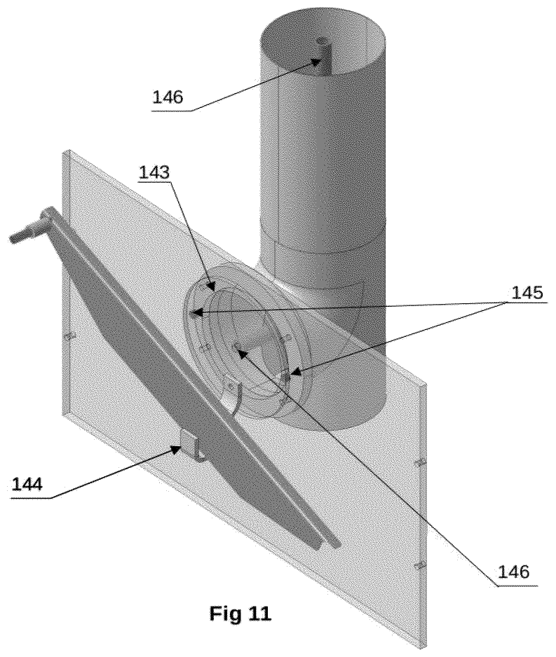

The cooling system of the present invention, which contains the cold source and the hot source, is provided with a humidification system because at the temperature difference, it dries the air and the circulation medium with its thermodynamics, having a direct effect of reducing the thermal conductivity of air, in particular in a closed circuit, where the humidification system of the present invention sprays directly at the module level, from the humidification network 146/FIG. 11, a network that can be separated, but integrated and not limited to and in the smoke exhaust column 147/FIG. 11, humidification controlled by humidity sensors 166/FIG. 8. installed to each battery module of the present invention.

The sensors of the present invention can be independent in separate devices and/or combined in a common device, and as long as they are determined by the description of the present invention and/or are part of the systems and/or sub-assemblies of the claims of the present invention, the particular sensors and/or the presented detection systems, form an integral part of the present invention.

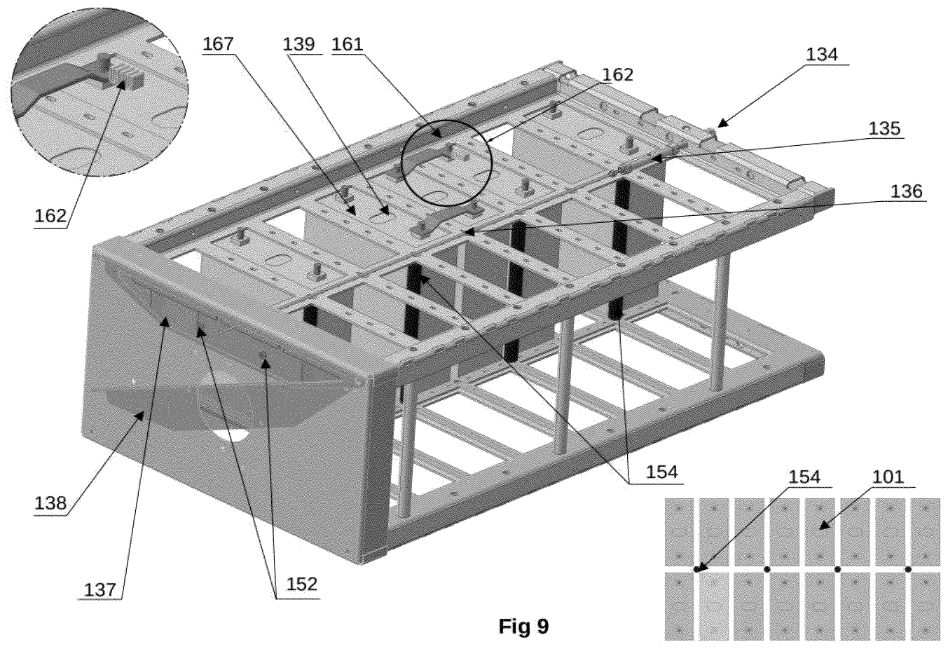

The cooling system shown can also comprise heat exchangers 162/FIG. 9, directly at the terminals and/or bars of the battery cells electrodes 161/FIG. 9, cooled by forced air from the cooling slots 124a/FIG. 5/FIG. 6.

The battery module of the present invention is provided with a 169/BMS/FIG. 8, which is essentially positioned at the opposite end of the turbine fan, and which in turn is cooled by the pressurized air flow from the upper and lower slot 124/FIG. 5, through the holes 132/FIG. 8. The BMS is compartmentalized separately from the battery cell enclosure, cooled separately with controlled flow through the holes 132/FIG. 8, electrically, thermally and fire insulated through the fibre cement walls 133/FIG. 8. and/or plates/materials based on silicate, of the battery modules of the present invention. Protected against overheating, electric shock, flammable combustible gas and fire that can come from battery cells. The described BMS protection is an integral part of the present invention and ensures electrical functionality and data communication, essential for monitoring, dispatching, automation and control of battery modules under accident/failure and/or fire conditions.

The electrical energy storage systems in batteries are provided with fire detection systems at the container level and extinguishing systems also at the container level and in the closet room. They detect hydrogen at a high-volume level after the smoke has contaminated several modules and/or several cabinets. The anti-fire system detects the open flame where the fire is already spreading at the level of modules or at the level of cabinets.

In the present invention, the solution represents a detection at the cell level inside the modules and an open flame extinguishing system also at cell level, all in the incipient stage, from the beginning, as detailed below.

The modules of the present invention are provided with a fire-protection and anti-fire system that is triggered specifically at the corresponding stages of staged damage of the battery cells. In stage one 1 of battery cell damage, in one or two batteries the internal resistance increases significantly and/or there is an internal short circuit between the anode and the cathode. This creates an electrochemical reactivity with release of heat and fuel gas with flammable hydrogen concentration. As a result, a closed reaction takes place in the aluminium capsule under pressure, which releases smoke and flammable gas. In the present invention, the module and the cabinet are provided with opening hatches for exhaust but also for suction through a suction circuit external to the module that triggers upon detection of hydrogen and/or other gases, smoke in/and at high temperature, leading to an extinguishing intervention, isolation, cooling, stopping the propagation and exhaust of the smoke/combustible gas generated by the reaction. This system does not allow smoke/fuel gas contamination to occur from one module to another, in the same cabinet or in the same system.

This stage and this system, which is an integral part of this invention, eliminates the generated smoke, and the second stage 2 of the battery cell damage is represented by the increase in temperature up to the thermophysical deformation of the battery and the occurrence of an open flame. At this stage, the module of the present invention is provided with, but not limited to, fire-protection liquid ampoules, which can be 154/FIG. 9, which can trigger in a controlled manner, by breaking the ampoules in case of open flame and/or at high temperatures. These ampoules are specifically positioned in direct contact with each battery cell, where, consequently, any of the module cells that may have an open flame can be extinguished by the fire-protection ampoules.

The fire-protection ampoules represented in 154/FIG. 9. can be triggered according to the invention with/or the help of incandescent resistors according to FIG. 154/FIG. 9, powered by the module's own energy. The smoke suction network and the anti-fire ampoules are an integral part of the present invention in that the smoke is detected and sucked directly from the source without contaminating other modules and the open flame is extinguished by fire-protection ampoules directly inside the module directly next to any battery cell of the modules. Consequently, the system allows action upon the source and internally.

In the present invention, the ampoules of anti-fire liquid are arranged axially in the middle, between the rows of battery cells, so that each ampoule is next to or attached to at least one battery cell and/or each cell is attached next to at least one ampoule according to 154/FIG. 9.

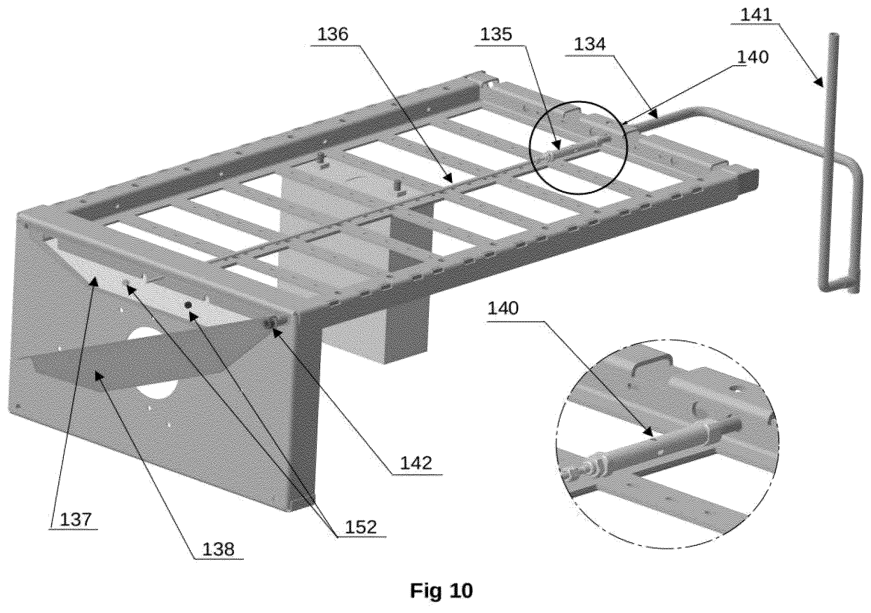

The battery module of the present invention is provided with a fire-protection and anti-fire system for direct intervention on the battery cells and directly inside the battery modules. The system is shown in FIG. 9, wherein through the network of inert gas and fire-protection agent mixture, under pressure through tube 134/FIG. 9. which feeds piston 135/FIG. 9. which is also activator by pushing the rod 136/FIG. 9/FIG. 10. opens the hatch 137/FIG. 9/FIG. 10. being able to be also supported by magnets 152/FIG. 10. which, by motion and rotation 138/FIG. 9/FIG. 10, opens the exhaust chain and does not obstruct neither the exhaust nor the suction of the smoke, taking into account that before the activation of the fire-protection and anti-fire process, the battery module was in closed circuit, hermetic and airtight.

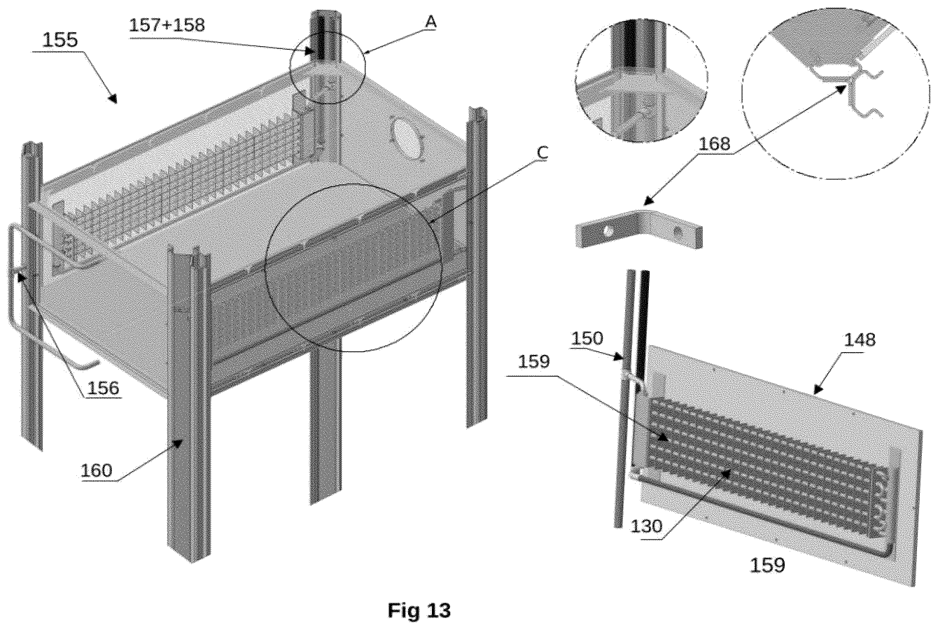

The anti-fire system of the present invention includes an actuator-cylinder-injector device 135/FIG. 9. which can be actuated by the pressure and energy of the inert gas mixed with fire-protection agent from the network 141/FIG. 9. respectively embedded 156/FIG. 13, or/and actuated electrically, electro-magnetically, elastically by spring, thermodynamically by heating and/or expansion, with its particularities of changing and/or transforming the battery module of the present invention, from a hermetically sealed module with forced closed circuit, into an open battery module.

The anti-fire system can also include a smoke exhaust and suction system and free passage to the smoke exhaust column 145/FIG. 11, by opening the hatch 137/FIG. 9/FIG. 10. of the module, which in turn can open the hatch 143/FIG. 11. of the rack of the floor of the module articulated or fixed in a slot, seals through the pressure of a spring, a mechanical or electromagnetic lock, and the battery module of the present invention, can include but not limited to a fire protection system provided with at least a fire-fighting ampoule 154/FIG. 9. inside the battery module, attached next to or in the vicinity of each battery cell, wherein the ampoules system can be arranged on the central axis of the battery module that can act directly on each battery cell.

The anti-fire system of the present invention can have and/or the particularity of anti-fire protection inside the battery module of the present invention, represented by, but not limited to, the fire-protection agent ampoule system, comprising also sprinklers, sprayers, pills and or sand pockets, which can act directly on the reaction, fire, combustion temperature, and/or can act directly by eliminating one of the 3 factors of fire, such as diluting or annihilating the fuel, oxygen and/or reducing the combustion temperature.

The tightness of the battery module of the present invention, also provided with the closed cooling circuit, is an essential system for the operation of the battery modules, and in the emergency situation when the battery module is compromised especially from a defective cell, the system becomes open and, at the same time, it also provides inert gas mixed with fire-protection agent added to a smoke suction to prevent it from spreading from one module to another.

In continuation of the intervention process on the defective cell or cells, the rack of the present invention is provided with a smoke exhaust column 147/FIG. 11. connected to each module and/or floor, and/or/with a distribution network 141/FIG. 10. respectively 156/FIG. 13. of inert gas and/or fire-protection agent mixture and at each module, the system of the present invention is provided with a second smoke exhaust hatch, which belongs to the rack, and which in turn is opened and/or triggered by the first smoke hatch that belongs to the module, previously presented and that forms an integral part of the present invention.

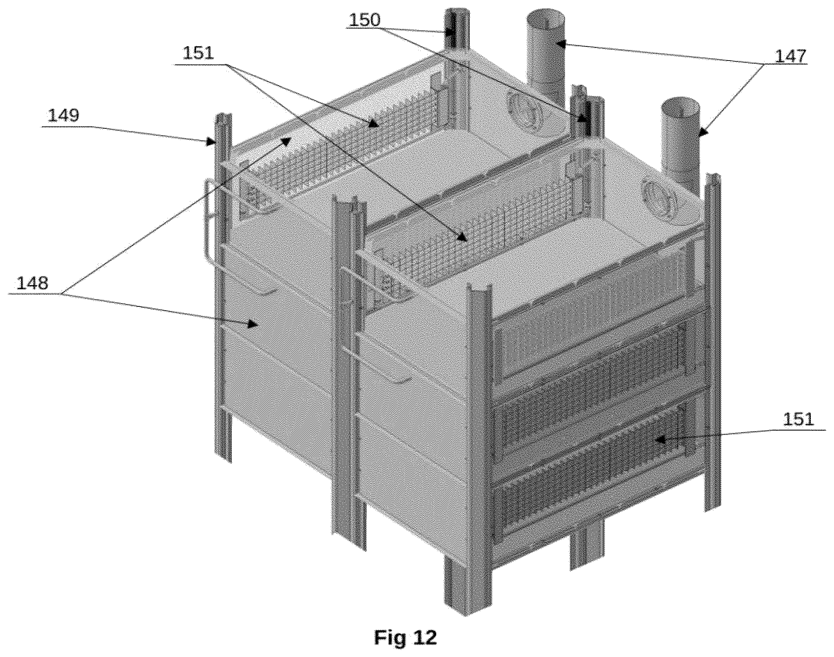

The perimeter of the 6 faces of the battery module of the present invention is composed of fibre cement panels according to 148/FIG. 12. which ensures the tightness of the closed circuit in the air-cooling mode, electrical, thermal and fire tightness and against the propagation of flammable gases in case of danger, from one module to another.

Upon detection of the defective cell or cells in a module of the present invention, the module in question and neighbouring modules are de-energized, the pressure in the inert gas and re-protection agent mixture circuit is opened, pushing the actuator piston into the problematic module and the adjacent modules, the cylinder by its actuation pushes the rod that opens the hatch of the module, at the same time the piston of the cylinder exceeds the injection holes of inert gas and fire-protection agent mixture, agent which are injected on the upper surfaces of the battery cells, where the discharge valves 139/FIG. 9. are located, on the discharge surface 167/FIG. 2. of the battery cells, acting directly upon the smoke, and the module hatch opens and rotates by pushing the cylinder rod, opening the rack hatch after it, completely opening the entire smoke exhaust column for exhaust and suction, system with the elements and the process which are an integral part of the present invention.

The modules of the present invention are assembled in racks and cabinets, which can have a metal structure 149/FIG. 12, with walls made of fibre cement sheets 148/FIG. 12. and/or plates/materials based on silicate, sealed to ensure the internal cooling flow in a closed circuit, where the radiators 151/FIG. 12. and the liquid cooling circuit 150/FIG. 12. can be an integral part of the cabinets, with the network of central liquid columns on each side of the liquid cooling radiators. The racks and cabinets can be assembled separately with the liquid cooling system, the battery modules can be assembled separately with the air-cooling system and with the electrical part with the Battery Management System (BMS) 169/FIG. 8, and the electrical energy storage system that forms the present invention can be represented by inserting the battery modules into the cabinet racks, like the drawers in a cabinet, in a modular manner FIG. 12. The racks and cabinets are attached in turn in groups that can be containerized with a central and/or individual cooling and pumping circuit, and formed into a series and/or electrically connected in parallel at group level, assembly that forms an integral part of the present invention.

The module system of the present invention is represented by the air circuit that belongs to the self-standing module “like a drawer in a closet” and the liquid cooling system belongs to the self-standing rack attached to its side walls. The advantage of the separation between the two circuits is that the module can be assembled and produced separately and assembled as a drawer in the cabinet, and the liquid cooling system in the radiators, pipes and pump belongs to the rack as a stand-alone system that can be central. The cooling system with the external environment can be connected and/or attached to the network of pipes assembled separately from the floors at the module level, which can be vertical without direct contacts with the modules and with an electrical source attached to a cooling system that can be with refrigerant and compressors with freon and/or ambient environment outside the batteries, if the external temperature is below the cooling temperature of the battery modules and/or the battery cells.

The system of the present invention is provided with external lateral walls and separated from the modules by sheets of fiber cement and/or plates/materials based on silicate, for an insulation of the thermal air flow and an anti-fire against the propagation of flammable gases which can be made of fiber cement and/or boards/materials based on silicate.

The module rack of the present invention can be composed of two or more battery modules represented in FIG. 12, where the battery modules are embedded like drawers into a cabinet, where the rack can be provided with metal structure 149/FIG. 12, smoke exhaust column 147/FIG. 12, walls made of fiber cement sheets 148/FIG. 12, liquid cooling network 150/FIG. 12, with flow route 157/FIG. 13, and return 158/FIG. 13. which can be embedded in the chassis of the rack, liquid cooling radiators 151/FIG. 12, and all components, materials, assemblies and sub-assemblies can be made of non-flammable and non-combustible materials, where all the mentioned elements constitute an integral part of the present invention.

The rack system 155/FIG. 13. of the present invention, can be provided with a frame 160/FIG. 13. which, by its geometry can take over from the inside, the columns 157-158/FIG. 13. and the embedded networks of cooling liquid as well as inert gas with fire-protection mixture 156/FIG. 13, has the mechanical resistance at least the same as a structure in a square or rectangular geometry, receives the insert on the floors for the perimeter structure on which in turn the crossbars will be placed, and also represent a key where two or more racks can be fixed and solidified together, between racks, as well as inside a Battery Energy Storage System (BESS) container which can have capacities of over 2 MWh. This specific geometry of the frame 160/FIG. 13. of the present invention, also presents a vertical border which, aligned with the border of the perimeters, represents a levelled straight band, with the aim of being hermetic when assembling the sub-assembly 159/FIG. 13. which is installed through the vertical walls, representing fiber cement sheet wall sub-assemblies with liquid cooling radiator as sub-assembly 159/FIG. 13, and tightness is an absolute necessity for the forced air-cooling system in closed circuit and hybrid with the liquid-based radiators, being systems, assemblies, sub-assemblies, geometries, processes and functions as an integral part of the present invention.

The absolute tightness at the level of the module and floor, isolates the modules from one another both thermally and electrically, as well as a barrier to the propagation of fire, smoke, combustible gas and resistance to a possible internal explosion. This tightness also allows for smoke exhaust, the injection of inert gas and fire-protection mixture and the suction to the intervention mode which transforms into the mode with floor of the rack open to the smoke column, previously described by opening the two smoke exhaust hatches 137/FIG. 9/FIG. 10. respectively 143/FIG. 11, and the other modules and floors remain closed, hermetic and isolated as the propagation barrier and protection, according to the systems and descriptions presented previously, representing an integral part of the present invention that solves the problems of the BESSs prior to the present invention.

Assembling and attaching the racks can be done through the solution of the geometry of the frames 160/FIG. 13. by fixing with a key 168/FIG. 13. used for fixing between racks and/or between the rack and the container structure that can represent a set of racks in the Battery Energy Storage System (BESS).

1. A modular battery system comprising:
Two or more battery modules (105) embedded like drawers into a cabinet,
A metal structure (149) for mechanical stability,
A smoke exhaust column (147) for removing smoke in case of an emergency,
Walls made of fiber cement sheets (148) that provide both fire resistance and structural integrity,
A liquid cooling network (150) embedded into the chassis, comprising a flow route (157) and a return path (158) that ensures efficient cooling of the battery modules,
Liquid cooling radiators (151) for heat dissipation, and
All components made of non-flammable materials to ensure safety and fire prevention.

2. The modular battery system of claim 1, wherein the liquid cooling network (150) is integrated into the chassis of the rack, and includes a flow route (157) and a return path (158) for circulating cooling liquid to remove heat from the battery modules.

3. The modular battery system of claim 1 or 2, wherein the battery modules (105) are thermally and electrically isolated from each other by fiber cement walls (148), which also act as a fire barrier and prevent the propagation of smoke and heat.

4. The modular battery system of any preceding claim, further comprising a temperature sensor that monitors the temperature of the battery modules (105) and automatically adjusts the operation of the liquid cooling system (150) to maintain optimal thermal conditions.

5. The modular battery system of claim 1, wherein the fire suppression system includes an inert gas injection system that displaces oxygen within the cabinet to prevent combustion.

6. The modular battery system of claim 5, wherein the battery modules (105) are provided with cooling fins integrated into the chassis, the fins being positioned adjacent to the liquid cooling radiators (151) to enhance heat dissipation and maintain optimal operational temperature.

7. The modular battery system of claim 6, further comprising a forced air-cooling system integrated with the liquid cooling system, wherein the forced air-cooling system operates in closed-circuit mode to maintain airflow through the battery modules (105) and cooperates with the liquid cooling radiators (151) to dissipate heat.

8. The modular battery system of any one of claims 1 to 7, wherein the fire suppression system includes an injection mechanism that releases a fire protection mixture (156) into the battery module cabinet upon detection of smoke or elevated temperatures, with the fire protection mixture designed to suppress fires and prevent combustion.

9. The modular battery system of claim 8, wherein the fire suppression system includes an inert gas injection system that releases an inert gas into the cabinet to displace oxygen and suppress any combustion, while also acting as a thermal barrier to prevent heat propagation between battery modules (105).

10. The modular battery system of claim 9, wherein the smoke exhaust system comprises a smoke exhaust column (147) that channels smoke away from the battery modules (105) through exhaust hatches (137) and prevents smoke from entering other modules, with the exhaust system capable of operating autonomously during fire suppression.

11. The modular battery system of claim 10, wherein the system includes a floor isolation mechanism that isolates the battery modules (105) from each other thermally and electrically, with the isolation mechanism comprising non-conductive and heat-resistant materials embedded into the floors and walls of the cabinet.

12. The modular battery system of any one of claims 1 to 11, wherein the system includes a mechanical frame structure (160) that supports the battery modules (105), with the frame designed to resist mechanical stress and provide a barrier to the propagation of heat and flames, the frame being constructed from fire-resistant and non-combustible materials.

13. The modular battery system of claim 12, wherein the system is installed within a Battery Energy Storage System (BESS) container with a capacity of over 2 MWh, the system further comprising mechanisms to securely connect multiple racks and ensure a stable and scalable energy storage solution.

14. The modular battery system of claim 13, wherein the system includes crossbars integrated into the frame structure (160) to provide additional structural stability, the crossbars ensuring that the battery modules (105) remain securely positioned within the cabinet and resist mechanical shocks or vibrations.

15. The modular battery system of any one of claims 1 to 14, wherein the system includes an intervention mode, triggered during an emergency, that automatically opens the smoke exhaust hatches (137) and activates the inert gas injection system, while maintaining hermetic isolation of the other battery modules (105) to prevent smoke or fire propagation.

16. The modular battery system of any one of claims 1 to 15, wherein the system is hermetically sealed at the level of each battery module (105), preventing the spread of fire, smoke, and combustible gases between modules, with the hermetic sealing achieved through the use of fiber cement walls (148) and liquid cooling radiators (151) integrated into the structure.
